(19) United States
(12) Patent Application Publication
(10) Pub. No.: US 2003/0075279 A1
(43) Pub. Date: Apr. 24, 2003

(54) Curing of adhesive materials particularly for glazing applications

(76) Inventors: Robert Marc Clement, Swansea (GB); Christopher Davies, Kidwelly (GB)

Correspondence Address: MERCHANT & GOULD PC, P.O. BOX 2903, MINNEAPOLIS, MN, 55402-0903, US

(21) Appl. No.: 10/057,525

(22) Filed: Jan. 24, 2002

(30) Foreign Application Priority Data
Jan. 25, 2001 (GB) 0102034.6

(51) Int. Cl. B65C 11/04

(52) U.S. Cl. 156/578; 156/579

(57) ABSTRACT

A hand-held operator manipulatable applicator device is used for dispensing adhesive bonding material to bond a panel (such as an automotive glazing panel). The device has a body containing a delivery channel for delivering adhesive to an outlet nozzle and a heating system disposed within the body for heating the bonding material in the channel to produce a substantially uniform outlet dispensing temperatures via the nozzles.

### FIELD OF THE INVENTION

The present invention relates to curing of adhesive materials particularly for panel replacement or repair in automotive applications and is particularly suitable for replacement of glazing panels or other panels in ‘in situ’ environments and locations such as in auto repair shops, in an outdoor environment or the like.

### BACKGROUND OF THE INVENTION

Modern automotive glazing is typically bonded into the vehicle using polyurethane (pu) adhesives. Automotive body panels are also sometimes bonded to a vehicle chassis or sub-frame using adhesives. These adhesives tend to be moisture cured, but thermally curing versions have been used. When a glazing panel (such as a front screen glazing panel) is replaced, the customer is advised not to use the vehicle for a prescribed period, known as the “drive away” time. In this time the pu adhesive material forms a skin on its surface and whilst it is not completely solid, the adhesive and cohesive forces are sufficient to keep the glazing panel in place, in the event of a collision. The forces exerted on the front screen glazing panel during an impact are due not only to its own inertia but also result from the inflation and operation of airbags where present.

The adhesive bonding material and glazing panels also provide vehicle strength and rigidity in the event of a roll over. It is clear that any adhesive material and application process must ensure vehicle integrity and the safety of the occupants.

The drive away time is specified by the pu adhesive bonding material manufacturer and is provided normally in tabular form. The table provides a glass replacement fitter with a time in minutes or hours for a range of ambient temperature and humidity. The figures in the table represent what the pu manufacturer knows to be safe times for adhesive to reach adequate mechanical strength. The quoted figure will also include a safety margin (probably 200%) on bonding strength to account for likely impact forces and variations in the adhesive product. The technique of the invention may have application in fields other than automotive glazing panel replacement, such as for example in automotive body panel repair or replacement, or architectural panel replacement (glazing or otherwise). Such panel replacement is either of necessity, or customer preference, carried out outdoors or in uncontrolled environments (such as repair shops).

U.S. Pat. No. 5,948,194 relates to a technique for dispensing adhesive bonding material onto an automotive glazing panel in an automated environment (vehicle production line) in which robot arm manipulation is co-ordinated with a fixed, heavy duty dispensing arrangement, including a variable power microwave source to dispense bonding material heated in a particular regime such that first dispensed material is dispensed at a different temperature to second dispensed material.

Applying heat to the pu adhesive bonding material for a set period of time (dependent on the heating apparatus) accelerates the gel and cure time of the adhesive. Once the pu adhesive material temperature has been elevated to an optimum temperature the heating mechanism is removed and the adhesive is allowed to cool. This temperature elevation has been found to increase the rate of cure. Realisation of this accelerated cure rate in the field results in faster drive away times, which is particularly relevant to automotive panel replacement industries such as automotive glazing panel replacement. For panel replacement in substantially uncontrolled environments such as repair shops or outdoors, the adhesive needs to be rapidly dispensed in a controlled manner and a consistent heating regime applied. In such circumstances controlled robotic apparatus is not appropriate and cost prohibitive.

An improved technique and apparatus for panel replacement (particularly automotive glazing panel replacement) has been devised.

### SUMMARY OF THE INVENTION

According to a first aspect therefore, the present invention provides a method of securing a panel with an adhesive bonding material, using hand-held operator manipulatable dispensing device to dispense adhesive bonding material via a dispensing outlet of the device, the method comprising subjecting the bonding material to a predetermined temperature regime, the predetermined temperature regime having:

(i) a period of heating the bonding material at a predetermined level prior to dispensing from the dispensing outlet of the device; and

(ii) a subsequent period of curing in-situ in contact with the glazing panel at a temperature significantly below the heating temperature level in step (i); wherein

the temperature of the adhesive bonding material dispensed via the dispensing outlet is maintained substantially uniform as adhesive is dispensed about the periphery of the panel.

It is preferred that the predetermined level to which the adhesive bonding material is heated is substantially at or above 50° C.

It has been found that, particularly where the adhesive bonding material is heated to 70° C.±20° C. and then left to cure (typically at ambient conditions of temperature and humidity), the pre-heating process increases the rate of gelling and so curing.

The heating of the adhesive bonding material is therefore preferably tailored to elevate the temperature of the bulk of the material to 70° C.±20° C. Bulk heating technology such as rf/microwave, dielectric or ultrasound can be utilised to cause this temperature elevation. Other energy delivery techniques (preferably bulk heating techniques) may be utilised.

The adhesive bonding material is preferably a “moisture cure” material, preferably a moisture cure, polyurethane adhesive bonding material. The subsequent rapid curing of “moisture cure” adhesive following application of the temperature regime in accordance with the invention is marked. “Moisture cure” is a term well known in the art; an alternative category of adhesive bonding material is commonly referred to as “heat cure” material. “Moisture cure” as used in the art typically refers to a bonding material which cures under ambient conditions in the presence of moisture/humidity. “Heat cure” is a term employed in the art meaning an adhesive bonding material which cures primarily through the application of heat substantially throughout the entire curing process.

The rate of gelling/curing of the pre-heated adhesive bonding material has been found to be at least twice that of adhesive bonding material not dispensed from a device in accordance with the procedure of the invention. It is the conclusion that the drive away time of a vehicle can be reduced if the pu adhesive bonding material is preheated for a finite length of time prior to dispensing and then left to undertake a normal “moisture” (humidity) cure. Due to the convenience of manipulation of the device, a substantially uniform temperature of dispensing of the adhesive via the dispensing outlet (nozzle) has been found particularly effective, and provides for rapid dispensing around the periphery of the panel or more typically around the frame to which the panel is to be fitted.

It is preferred that the heating (temperature elevation stage of the process) should not be applied to an extent such that an upper temperature limit is exceeded. If this occurs, it has been found that excessive and premature gelling or curing of the adhesive material is imparted. Preferably gelling and curing of the adhesive material occurs following the heating stage.

Samples were tested at intervals of 5 minutes for surface tackiness using a white card. This a test specified by the pu manufacturer as an on site method for checking for suitable gelling of the adhesive. To pass the test the white card must touch the pu surface and be removed without any black adhesive being attached. From the in house testing it has been shown that the preheating process increases the rate of gelling and so curing.

Heating of the adhesive material contemporaneously with dispensing of the adhesive material is preferred. The adhesive material is typically dispensed (preferably extruded) onto either the back face perimeter of the glazing panel/windscreen or onto the vehicle aperture frame.

The adhesive material is preferably dispensed/extruded using an applicator device (such as an applicator extrusion gun).

According to a second aspect, the invention therefore provides an applicator device for dispensing adhesive material, the applicator device being hand-held and operator manipulatable and comprising a body portion including a delivery channel for delivery of adhesive bonding material to a dispensing outlet nozzle, the body portion further including an operator actuatable heating arrangement for heating the adhesive bonding material to a predetermined temperature level to produce a substantially consistent outlet dispensing temperature via the nozzle.

The short travel distance of the adhesive bonding material between the heating zone and the nozzle ensures a consistent and accurate dispensing temperature. The device can be rapidly manoeuvered (due to its compactness) resulting in speedy application of adhesive around the panel or the frame to which the panel is to be bonded.

The device preferably includes a nozzle or nozzle receiving portion, the heater device being provided adjacent the nozzle or nozzle receiving portion. It is particularly preferred that the heating means is positioned and configured for heating of the adhesive material whilst present in the nozzle.

The heater is provided for the applicator device in order to permit the adhesive material temperature to be elevated as it is dispensed/extruded. The applicator device, in addition to having an adhesive material heating arrangement, is preferably configured to accept the adhesive material in canister/package form (single or multi shot). Dispensing via a nozzle is preferred. Preferably disposable nozzles are provided. Adhesive material packages (typically for single shot) and nozzles may be fitted prior to use and removed and disposed of subsequently. It is preferred that an actuation switch or trigger is operator actuatable to simultaneously initiate the heating arrangement and feed arrangement for urging the material along the delivery channel toward the outlet/nozzle.

The heating arrangement is beneficially provided in the body of the applicator device disposed forwardly of the actuation switch or trigger. This provides ergonomic advantages and good balancing of the device for operator handling.

Although the curing technology described above has been described primarily for bonding windscreens (for which it is particularly convenient to reduce cure times), the system can be used on any bonded glazing or other panels, particularly such glazing or other panels utilising pu or other (moisture cure) adhesives.

The invention will now be further described in specific embodiments.

### BRIEF DESCRIPTION OF THE DRAWINGS

FIG. 1 is a schematic view of a hand-held applicator device according to the invention;

FIG. 2 is a sectional view of an alternative applicator device for use according to the method of the invention;

FIG. 3 is a front end elevation of the device of FIG. 2; and

FIG. 4 is a rear end elevation of the device of FIGS. 2 and 3.

### DETAILED DESCRIPTION OF THE PREFERRED EMBODIMENTS

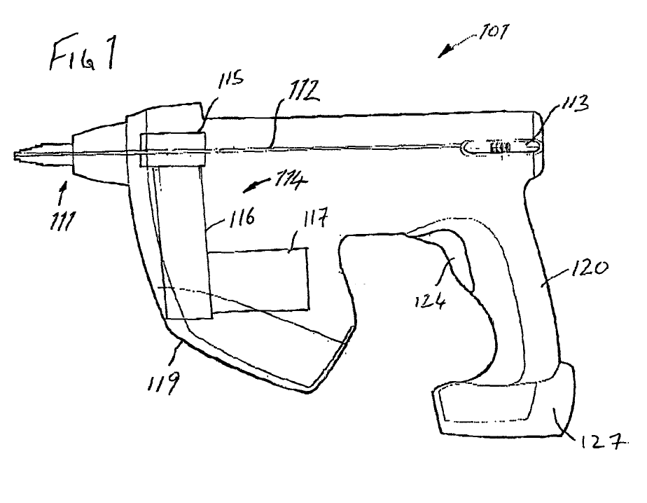

Referring to the drawings and initially to FIG. 1, an extrusion adhesive applicator device 101 is provided with a nozzle 111 at a first end of a delivery channel or duct 112, the channel or duct 112 extending to a cannister loaded chamber 113. A microwave energy delivery heater arrangement 114 is disposed within the applicator body to effect the desired heating of the adhesive material in the channel or duct 112 in order to ensure dispensing via the nozzle 111 at the required temperature. Typically a uniform dispensing temperature out of nozzle 111 of 70° C.±20° C. is preferred.

The microwave energy delivery heater arrangement 114 comprises a check piece 115 surrounding a relevant portion of the channel or duct 112, an optimised microwave cavity 116 and a microwave generator 117. The microwave arrangement is positioned within a forward portion 119 of the housing of the device which defines a hand locator spaced from the handle and trigger portion 120. The adhesive is contained within a canister 112 loaded into the chamber 113. The trigger 124, when actuated, operates to urge the adhesive material from chamber 113 along the duct/channel 112 by means of a piston drive arrangement or a screw drive arrangement (or other drive arrangements known in the art). Actuation of the trigger arrangement also energises the controlled output of the microwave heater arrangement 114. Power supply for the arrangement is provided via an integral power supply 127. The cannister 113 is either ruptured on insertion into the receiving chamber or rupture may be initiated upon actuation of the trigger 124.

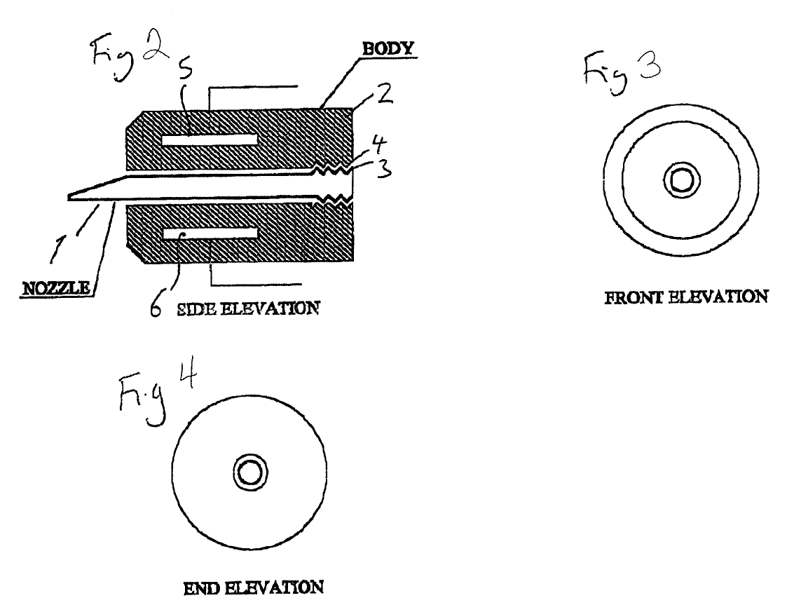

In an alternative embodiment, shown in FIGS. 2 to 4 a nozzle 1 on body 2 is provided with complementary entry engaging screw thread formations 3, 4 to permit secure connection.

The heater body 2 includes electrodes 5, 6 actuatable to set up a bulk heating radio frequency field to elevate the temperature of adhesive material in the nozzle 1 to 70° C.±7° C. prior to the material being extruded from the end of nozzle 1. The rate of extrusion of the material is co-ordinated with the heat applied via electrodes 5, 6 to ensure that the Radio Frequency (RF) bulk heating of the adhesive material in the nozzle to ensure that extruded material has been heated to the required temperature.

Bulk heating of the material is preferred using an energy field which is substantially uniform through the bonding material. This promotes substantially uniform heating of the adhesive bonding material throughout the body of the material which results in uniform application of energy. The energy field is preferably electromagnetic and may comprise microwave energy (preferably directed by microwave wave guide) or alternatively Radio Frequency (RF) heating may be utilised.

As an alternative to the use of RF heating, the heater body 2 may include microwave generator means and/or a microwave guide means for bulk heating the adhesive material in nozzle 1 to the required temperature. As a further alternative, the heater body 2 may include an ultrasonic generator and/or ultrasonic wave guide in order to effect bulk heating of the adhesive material in nozzle 1 by means of ultrasonic energy delivery. As a further alternative dielectric heating may be utilised. A microwave arrangement provides advantages in that relatively reliable microwave technology may be adapted and microwave suppliers provide economic advantages. Ultrasound, dielectric and RF arrangements may be technically equal to microwave and do not risk microwave energy leakage.

The adhesive material in extruded by the applicator gun device either directly onto the glazing panel, or to the frame into which the glazing panel is to be secured. Thereafter, the prior heated adhesive material is allowed to cure under ambient conditions.

The adhesive bonding material is preferably a “moisture cure” material preferably a moisture cure polyurethane adhesive bonding material. “Moisture cure” is a term well known in the art, and an alternative category of adhesive bonding material is being referred to as “heat cure” material. “Moisture cure” as used in the art typically refers to a bonding material which cures under ambient conditions in the presence of moisture. “Heat cure” is a term employed in the art meaning an adhesive bonding material which cures primarily through the application of heat substantially throughout the entire curing process.

Whilst the invention has particular applications for use in vehicle windscreen replacement (in that drive-away times are significantly reduced). It is envisaged that the technique would have technical and commercial benefit use in other glazing applications, or indeed in other situations where screens, panels or the like require bonding.

What is claimed is:

1. A method of securing a panel with an adhesive bonding material, using hand-held operator manipulatable dispensing device to dispense adhesive bonding material via a dispensing outlet of the device, the method comprising subjecting the bonding material to a predetermined temperature regime, the predetermined temperature regime having:
(i) a period of heating the bonding material at a predetermined level prior to dispensing from the dispensing outlet of the device; and
(ii) a subsequent period of curing in-situ in contact with the glazing panel at a temperature significantly below the heating temperature level in step (i); wherein
the temperature of the adhesive bonding material dispensed via the dispensing outlet is maintained substantially uniform as adhesive is dispensed about the periphery of the panel.

2. A method according to claim 1, wherein the adhesive bonding material is a moisture cure adhesive bonding material.

3. A method according to claim 1, wherein the predetermined level to which the adhesive bonding material is heated prior to dispensing from the dispensing device is substantially at or above 50° C.

4. A method according to claim 1, wherein the predetermined level to which the adhesive bonding material is heated prior to dispensing from the dispensing device is substantially in the range 70° C.±20° C.

5. A method according to claim 1, wherein the temperature of the adhesive bonding material as dispensed is maintained at a uniform temperature of 5° C. during dispensing about a panel or the frame to which the panel is to be bonded.

6. A method according to claim 1 wherein the uniform dispensing temperature of the adhesive bonding material dispensed from the device is 70° C.±20° C.

7. A method according to claim 1, wherein a minor degree of curing of the adhesive bonding material occurs during the in applicator device heating stage.

8. A method according to claim 1, wherein a bulk heating technique is utilised to heat the adhesive bonding material.

9. A method according to claim 1, wherein dielectric heating is used to heat the adhesive bonding material.

10. A method according to claim 1, wherein microwave heating is used to heat the adhesive bonding material.

11. A method according to claim 1, wherein Radio Frequency heating is used to heat the adhesive bonding material.

12. A method according to claim 1, wherein ultrasonic heating is used to heat the adhesive bonding material.

13. A method according to claim 1, wherein heating by electromagnetic radiation is used to heat the adhesive bonding material.

14. A method according to claim 1, wherein following the heating stage and dispensing the adhesive bonding material applied to secure the panel is permitted to cure in situ in ambient conditions.

15. A method according to claim 1, wherein the heating stage is carried out prior to positioning the panel and adhesive bonding material for securing.

16. An applicator device for dispensing adhesive material, the applicator device being hand-held and operator manipulatable and comprising a body portion including a delivery channel for delivery of adhesive bonding material to a dispensing outlet nozzle, the body portion further including an operator actuatable heating arrangement for heating the adhesive bonding material in the channel, internally of the device to a predetermined temperature level to produce a substantially constant outlet dispensing temperature via the nozzle.

17. An applicator device according to claim 16, including a drive arrangement to urge the adhesive material along the delivery channel toward the outlet nozzle, actuation of the drive arrangement and the heating arrangement being by means of a common operator manipulatable actuator.

18. An applicator device according to claim 16, wherein the heating arrangement is self-contained in a body portion of the applicator device positioned forwardly of the operator manipulatable actuator.

19. An applicator device according to claim 16, wherein the heating arrangement comprises a dielectric heating arrangement to heat the adhesive bonding material.

20. An applicator device according to claim 16, wherein the heating arrangement comprises a microwave heating arrangement to heat the adhesive bonding material.

21. An applicator device according to claim 16, wherein the heating arrangement comprises a Radio Frequency heating arrangement to heat the adhesive bonding material.

22. An applicator device according to claim 16, wherein the heating arrangement comprises an ultrasonic heating arrangement to heat the adhesive bonding material.

23. An applicator device according to claim 16, wherein the device is configured to accept the adhesive material in canister or package form.
